(19) United States
(12) Patent Application Publication
(10) Pub. No.: US 2009/0225531 A1
(43) Pub. Date: Sep. 10, 2009

(54) Night vision imaging system (NVIS) compliant backlight

(76) Inventor: Michael R. Praiswater, Albuquerque, NM (US)

Correspondence Address: HONEYWELL INTERNATIONAL INC.;PATENT SERVICES, 101 COLUMBIA ROAD, P O BOX 2245, MORRISTOWN, NJ, 07962-2245, US

(21) Appl. No.: 11/702,367

(22) Filed: Feb. 2, 2007

(51) Int. Cl. G02F 1/13357; G09F 13/04

(52) U.S. Cl. 362/97.2; 362/97.1

(57) ABSTRACT

A dual mode illumination system with a primary mode providing high efficiency high brightness illumination and a secondary mode providing NVIS compliant illumination. The primary light source is direct view, not NVIS filtered and used for non-NVIS applications. The secondary light source is filtered for NVIS compliance and is not in direct view. During NVIS applications the primary light source is turned off and light from the secondary source is directed toward the viewer through a light guide. Both light sources are mounted on the same plane.

### BACKGROUND OF THE INVENTION

1. Field of the Invention (Technical Field)

This present invention relates to night vision imaging systems (NVIS), and more particularly to backlights for transmissive displays required to meet NVIS radiance requirements. It also relates to general illumination assemblies, which are used with night vision goggles.

2. Background Art

The invention resulted from the desire to create a simple, low cost, scalable NVIS compliant backlight while maintaining optical efficiency and suitable heat sinking in an active-matrix liquid crystal display (AMLCD) system. Typically, optical filters are used to achieve NVIS compliance for full color displays and the filters are placed between the viewer and the light source. The optical filter may be over the entire backlight opening or just over the light source used for NVIS mode operation.

There are multiple examples of these types of backlight architectures. U.S. Pat. No. 5,661,578 discloses separate daytime and nighttime light sources. The NVIS compatible nighttime source is positioned to be out of sight of a user and produces an appropriately filtered, substantially collimated beam which diffusively reflects from the inside walls and base of the display housing before it illuminates the display surface. This device uses a NVIS filter located over an indirect nighttime lamp assembly used to achieve NVIS compliance.

U.S. Pat. No. 6,111,622 discloses a fluorescent lamp for daytime operation and a separate light source for nighttime operation which emits a low-intensity light. The nighttime light source is an electroluminescent panel which also acts as a daytime reflector of light. An integral image-splitting and collimating lens is provided to increase the uniformity of the light emitted and to provide wide angle viewability. U.S. Pat. No. 6,100,952 discloses a backlight that includes a ridged prismatic TIR with an embedded diffuser layer doped with an infrared (IR) absorbing dye, a ridged prismatic TIR without diffuser layer, an infrared rejecting filter layer, and either a holographic diffuser layer or a lenticular lens array layer, or a fresnel wedge layer. Both of these patents describe covering the entire AMLCD with an NVIS filter.

U.S. Pat. No. 6,842,204 teaches a LCD display which includes a normal mode light source, a liquid crystal display stack positioned so as to receive light from the normal mode light source, and a night vision imaging system (NVIS) mode light source. The NVIS mode light source includes a NVIS mode white light source, a NVIS mode red light source, a NVIS filter receiving light from both the NVIS mode white light source and the NVIS mode red light source, and a waveguide receiving light from the NVIS filter for reflection to the LCD stack. U.S. Pat. No. 5,211,463 discloses a duel system wherein the day lighting system uses conventional fluorescent or incandescent lamps for full color display during daytime use. The night lighting system uses a light source which is either filtered to remove infrared and near infrared wavelengths or which is chosen from a class of sources which does not emit such wavelengths. The day lighting system is disabled while the night system is in use. Both of the patents disclose devices that use a NVIS filter over the NVIS mode light sources with a light guide.

These existing prior art approaches for providing NVIS compliance for a full color display make use of primary and secondary lighting systems. Some systems use an optical filter covering the entire backlight opening and some systems use an optical filter covering just the light source used for NVIS mode operation. Filters that cover the entire display surface can be large and very expensive. The optical filters attenuate the visible spectrum significantly and can be a source of inefficiency in a high brightness display system. Other NVIS compliant backlight systems using indirect lighting techniques for the NVIS filtered light source are not easily scalable to other shapes and sizes or use indirect light sources that are difficult to construct and difficult to remove the generated heat.

### SUMMARY OF THE INVENTION (DISCLOSURE OF THE INVENTION)

The present invention is a dual mode illumination system with a primary mode providing high efficiency high brightness illumination and a secondary mode providing NVIS compliant illumination. The primary light source is direct view, not NVIS filtered and used for non-NVIS applications. The secondary light source is filtered for NVIS compliance and is not in direct view. During NVIS applications the primary light source is turned off and light from the secondary source is directed toward the viewer through a light guide. Both light sources are mounted on the same plane.

A primary object of the present invention is to provide an illumination system which does not interfere with the use of night vision goggles. This system can be used for backlighting transmissive displays or as a general ambient illumination system.

A primary advantage of the invention it that it allows both the primary and NVIS light sources to be mounted on the same plane or orientation. If LEDs are used as the light sources, the NVIS mode and primary mode LEDs may be mounted on the same PWB.

Another advantage is the invention is easily scalable from small displays to large displays by scaling the size of the light guide and primary light source to the size of the AMLCD.

Another advantage is that light from the primary light source is unfiltered so the color and efficiency of the lighting system is not degraded by the NVIS filter during non-NVIS applications.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 depicts a prior art light guide.

FIG. 2 is cross section of the preferred embodiment of the invention.

### DESCRIPTION OF THE PREFERRED EMBODIMENTS (BEST MODES FOR CARRYING OUT THE INVENTION)

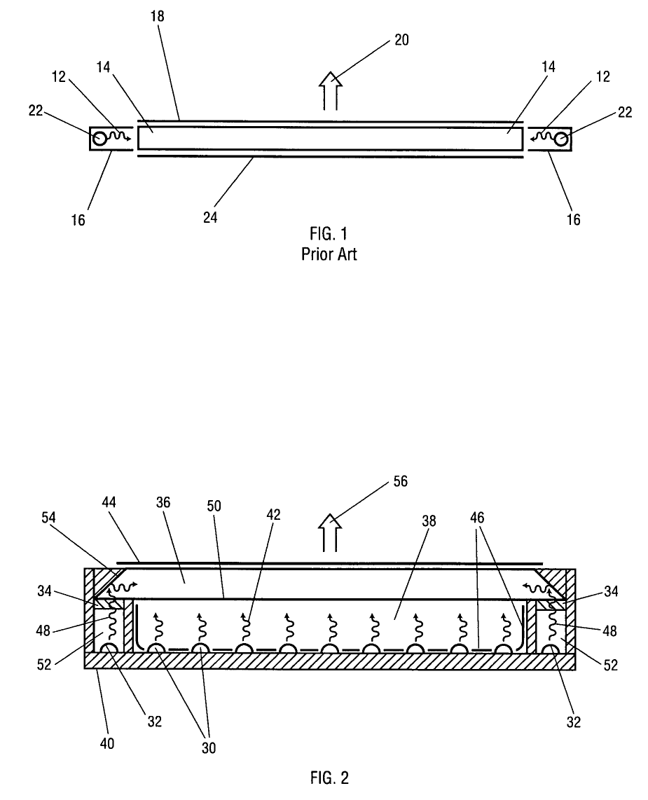

The present invention improves on the design and method for using a prior art light guide. FIG. 1 depicts a typical prior art light guide used in LCD monitors. Light guide 14 is rectangular in shape. Light 12 from light source 22 enters ends of light guide 14 as shown. Reflectors 16 improve the efficiency of light source 22 by directing all emitted light 12 into light guide 14. The light propagates the length of light guide 14 by total internal reflection. The prior art light guide 14 has a pattern of dots, grooves or other treatment (not shown) on the surface to scatter the propagating light toward diffuser 18 to provide diffuse light 20. Reflector 24 improves efficiency be reflecting back-scattered light toward the diffuser.

FIG. 2 is a cross sectional view of the preferred embodiment of the invention. The preferred embodiment consists primarily of a primary light source 30, secondary light source 32, NVIS filter 34, light guide 36, light integrating cavity 38 and mounting plate 40. Primary light source 30 is enclosed in a light-integrating cavity 38. In primary mode or during non-NVIS applications the majority of light 42 produced by primary light source 30 passes through light guide 36. Light guide 36 is made of a material highly transparent to visible light to maximize luminous efficiency. A diffuser 44 is placed in front of light guide 36 to give the illumination system a uniform light output. Because some light is reflected back into the light integrating cavity 38 from diffuser 44 and light guide 36, the cavity 38 walls are be covered with a high reflectance material 46 to reflect light back into light integrating cavity 38 and eventually through light guide 36 and diffuser surface 44. The primary light source 30 may be a bent fluorescent lamp or lamps, an array of straight fluorescent lamps or an array of LEDs. The reflective light-integrating cavity 38 should be of sufficient depth to provide diffuse light on the surface of diffuser 44.

Secondary light source 32 may be a fluorescent lamp or LED. Primary light source 30 is disabled when secondary light source 32 is used for NVIS compliant operation. Light 48 from secondary light source 32 passes through an NVIS filter 34 and enters light guide 36 from the same surface 50 or plane as primary light source 30. NVIS filter 34 limits the amount of infrared or near infrared spectral content in the light that interferes with the operation of NVIS goggles produced by secondary light source 32. Secondary light source 32 is mounted in a sealed compartment 52 to ensure no light from secondary light source 32 enters light integration cavity 38 without passing through NVIS filter 34.

Light guide 36, which is commonly used in commercial LCD monitors as described above, is modified for this invention. The current invention uses the same principles as the common light guide except light enters from the rear instead of the ends. The rectangular shape of the common light guide is modified by beveling edges 54 of light guide 36. Light from secondary light source 32 enters light guide 36 from the rear and reflects off of beveled edges 54 into the light guide 36. Light propagating through light guide 36 reflects off of the light guide surface pattern (not shown) toward the diffuser 44 and provides a diffuse source of NVIS compliant light 56.

Primary light source 30 and secondary light source 32 are attached to mounting plate 40 in the same orientation to emit light toward light guide 36 and diffuser 44. Mounting plate 40 provides structural integrity to the illumination system and acts as a heat sink for the light sources.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above, are hereby incorporated by reference.

What is claimed is:

1. A backlight for high luminance applications and night vision applications, the backlight comprising:
a primary light source disposed on a plane behind a light guide wherein light emitted from the primary light source is directed to a diffuser; and
at least one secondary light source disposed on said plane, where in said at least one secondary light source is encased in a compartment separate from the primary light source, whereby light emitted from the at least one secondary light source passes through a NVIS filter and is reflected by at least one beveled edge into said light guide and directed to the diffuser.

2. The backlight of claim 1 further comprising a light integrating cavity for said primary light source.

3. The backlight of claim 2 wherein said light integrating cavity comprises high reflectance cavity walls.

4. The backlight of claim 2 wherein said light integrating cavity comprises a predetermined depth to provide diffuse light to said diffuser.

5. The backlight of claim 1 wherein said plane comprises a mounting plate.

6. The backlight of claim 1 wherein said mounting plate is parallel to a direction of said light guide.

7. The backlight of claim 1 wherein said light guide comprises a material highly transparent to visible light.

8. The backlight of claim 1 wherein said primary light source comprises a member selected from the group consisting of at least one bent fluorescent lamp, an array of straight fluorescent lamps and an array of light emitting diodes.

9. The backlight of claim 1 further comprising a primary light source disabler for disabling said primary light source when said at least one secondary light source is activated.

10. The backlight of claim 1 wherein said at least one beveled edge comprises a first beveled edged disposed on a first end of said light guide and a second beveled edge disposed on a second end of said light guide.

11. A transmissive display containing the backlight of claim 1.

12. A method for backlighting for high luminance applications and night vision applications, the method comprising the steps of:
emitting light from a primary source through a light guide and to a diffuser, wherein the primary light source is disposed an a plane;
disposing at least one secondary light source on the plane, whereby the at least one secondary light source is encased to direct secondary source emitted light to a NVIS filter;
passing the secondary source emitted light through a NVIS filter; and
reflecting the passed light by at least one beveled edge of the light guide whereby the reflected light is directed to the diffuser.

13. The method of claim 12 further comprising the step of reflecting the emitted light from the primary light source in a light integrating cavity.

14. The method of claim 12 wherein the plane is located behind the light guide.

15. The method of claim 12 further comprising disabling the primary light source when the at least one secondary light source is activated.

16. The method of claim 12 wherein the step of reflecting the passed light comprises reflecting the passed light from a first secondary light source off a first beveled edge of the light guide and reflecting the passed light from a second secondary light source off a second beveled edge of the light guide.
